(19) United States
(12) Patent Application Publication
(10) Pub. No.: US 2017/0351871 A1
(43) Pub. Date: Dec. 7, 2017

(54) Data Owner Controlled Data Storage Privacy Protection Technique

(71) Applicant: Eric Alan Christiansen, Pittsburg, CA (US)

(72) Inventor: Eric Alan Christiansen, Pittsburg, CA (US)

(21) Appl. No.: 15/607,537

(22) Filed: May 29, 2017

Related U.S. Application Data
(60) Provisional application No. 62/346,725, filed on Jun. 7, 2016.

(51) Int. Cl. G06F 21/62; G06F 21/60; G06F 21/78; H04L 29/06

(52) U.S. Cl. CPC G06F 21/6218; H04L 63/06; H04L 63/0428; G06F 21/602; G06F 21/78; G06F 21/6245; H04L 63/0407

(57) ABSTRACT

This patent describes methods which allow the primary owners of sensitive data to retain more access control over the data they share with secondary service providers, even when the secondary service provider electronically stores some form of this information in a service provider maintained database. When these methods are applied by both data owner and service provider the data can only be accessed and used by the service provider during data owner controlled access sessions. This is accomplished through a special set of methods to apply a set of standard encryptions and a special set of methods to manage the associated cryptographic keys. Unencrypted sensitive data need never be permanently stored in a database. Each data owner has their own unique set of cryptographic keys. Critical decryption keys are never permanently stored in service provider databases. Methods are included to allow previously stored data to be recovered even if the data owner loses or forgets the primary password or access key. Service provider host and database administrators, or hackers who have gained such access, are more effectively blocked from accessing the sensitive data. There is no reliance on obfuscation techniques. Many, many cryptographic keys, not just one, would have to be cryptographically compromised in order to access many records. These methods make massive unauthorized extraction of sensitive data by hackers far more difficult while still supporting effective data sharing suitable for many applications.

### CROSS-REFERENCE TO RELATED APPLICATION

This application claims the benefit of U.S. Provisional Application No. 62/346,725, filed Jun. 7, 2016.

### BACKGROUND

Unauthorized data breaches of large service provider databases which contain sensitive information collected from many individuals can sometimes result in the exposure of data from millions of individuals, even when the data is stored in an encrypted database. For example, the infamous “Backoff” breach of the retail giant Target in 2013/2014 exposed more than 40 million payment card numbers. Service providers, such as Target, generally store sensitive data in encrypted databases. Standards such as the Payment Card Industry Data Security Standard mandate such encryption. Yet the massive data breaches continue.

A fundamental problem is that protecting an actively used service provider database using encryption is not fully cryptographically secure because the decryption key to that database must also be somewhere on the database server. This is analogous to the problem of Digital Rights Management which tries to protect e-book, video, and other copyrighted material from unauthorized copying by some form of encrypted copy protection scheme. However, such approaches, while providing some disincentive to copying, clearly are not very effective as evidenced by the easy availability of tools to bypass these copy protection schemes. The problem is that in order for such media to ever be readable or playable, all of the information needed to do so, including the decryption key, must be somewhere within the media. Such keys are generally hidden or obfuscated within the media, but obfuscation is not as secure as encryption, and if the obfuscated key is found, the encryption protection is compromised. Service providers with encrypted databases have the same problem, if they are to actually retrieve unencrypted data from the encrypted database, the decryption key must be present somewhere on the database server. A hacker who finds this key can generally then decrypt and extract all the data they want from such a database. The methods of this invention address this problem because each data owner gets a separate decryption key, and that key is never permanently stored on the database server and is only temporarily generated under data owner control for temporary data access sessions.

A major problem with this type of approach, where the data owner keeps the primary data decryption secret, is that the data owner might lose or forget this secret. In many environments this is handled with a password reset operation wherein the data owner is authenticated using alternative authentication credentials. However, such a reset would typically result in previously encrypted data being permanently inaccessible, essentially lost. However, the methods of this invention provide a special mechanism to allow such data to be securely recovered using the secondary authentication credentials.

Another problem is that if a data owner changes their primary secret (such as a password), either through a standard secret change (where the old secret is still known) or through a secret reset (where the old secret has been lost) the underlying data must generally be re-encrypted, which can be a time-consuming activity, and some of the encrypted data, such as historical activity, may even have been moved offline and is no longer directly accessible. However, the methods of this invention avoid this problem through the use of multiple indirect encryptions and keys such that the base level encrypted data never needs to be re-encrypted, only some of the intermediary keys.

### BRIEF SUMMARY OF THE INVENTION

This invention describes methods which can help secure sensitive data obtained from individual people or entities stored in the databases of service providers who sometimes use this data. This invention describes new and unique methods of applying standard one-way encryption algorithms, symmetrical encryption algorithms, and asymmetrical encryption algorithms together in a coordinated fashion in order to shift more control of sensitive information back to the original data owner, remove primary decryption keys from the service provider computer server, establish per-user data encryption keys, and securely support both standard password changes (where the old password is still known) as well as special password resets (where the old password is lost) without any loss of previously stored data.

### BRIEF DESCRIPTION OF THE DRAWINGS

FIG. 1: Account Creation Process—Phase 1 of 3. Shows the first phase of the process to create a new data owner account on a service provider computer server.

FIG. 2: Account Creation Process—Phase 2 of 3. Shows the second phase of the process to create a new data owner account on a service provider computer server.

FIG. 3: Account Creation Process—Phase 3 of 3. Shows the third phase of the process to create a new data owner account on a service provider computer server.

FIG. 4: Account Logon Process—Phase 1 of 3. Shows the first phase of the process to log a data owner onto a service provider computer server account.

FIG. 5: Account Logon Process—Phase 2 of 3. Shows the second phase of the process to log a data owner onto a service provider computer server account.

FIG. 6: Account Logon Process—Phase 3 of 3. Shows the second phase of the process to log a data owner onto a service provider computer server account.

FIG. 7: Sensitive Data Storage Process—Phase 1 of 3. Shows the first phase of the process to store especially protected data.

FIG. 8: Sensitive Data Storage Process—Phase 2 of 3. Shows the second phase of the process to store especially protected data.

FIG. 9: Sensitive Data Storage Process—Phase 3 of 3. Shows the third phase of the process to store especially protected data.

FIG. 10: Sensitive Data Retrieval Process—Phase 1 of 1. Shows the process to retrieve especially protected data.

FIG. 11: Change Password Process—Phase 1 of 3. Shows the first phase of the process to change an account password.

FIG. 12: Change Password Process—Phase 2 of 3. Shows the second phase of the process to change an account password.

FIG. 13: Change Password Process—Phase 3 of 3. Shows the third phase of the process to change an account password.

FIG. 14: Reset Password Process—Phase 1 of 10. Shows the first phase of the process to reset an account password.

FIG. 15: Reset Password Process—Phase 2 of 10. Shows the second phase of the process to reset an account password.

FIG. 16: Reset Password Process—Phase 3 of 10. Shows the third phase of the process to reset an account password.

FIG. 17: Reset Password Process—Phase 4 of 10. Shows the forth phase of the process to reset an account password.

FIG. 18: Reset Password Process—Phase 5 of 10. Shows the fifth phase of the process to reset an account password.

FIG. 19: Reset Password Process—Phase 6 of 10. Shows the sixth phase of the process to reset an account password.

FIG. 20: Reset Password Process—Phase 7 of 10. Shows the seventh phase of the process to reset an account password.

FIG. 21: Reset Password Process—Phase 8 of 10. Shows the eighth phase of the process to reset an account password.

FIG. 22: Reset Password Process—Phase 9 of 10. Shows the ninth phase of the process to reset an account password.

FIG. 23: Reset Password Process—Phase 10 of 10. Shows the tenth phase of the process to reset an account password.

### DETAILED DESCRIPTION

### Key Terms

For purposes of this invention the following key terms are defined and/or clarified.
“Account Owner”. See “Data Owner”.
“Asymmetrical Encryption”. Sometimes also called public key encryption. It uses a pair of keys, usually called a public key and a private key, for encryption and decryption. If the private key is used to encrypt, then the public key is used to decrypt. Similarly, if the public key is used to encrypt, then the private key is used to decrypt. An example of an asymmetrical encryption algorithm is RSA.
“Ciphertext”. Encrypted data, as opposed to unencrypted plaintext.
“Database”. Any mechanism used on a computer to store and retrieve data in a non-volatile fashion. This could be a computer file, a relational database system, a non-relational database system, etc.
“Data Owner”. Also sometimes referred to as the account owner. An individual person or entity which is the original source for data shared with a service provider. While in some cases the terms and conditions of a service provider indicate that the service provider also owns this data once shared, for purposes of this invention “data owner” refers to the primary or original individual data owner. For example, an individual credit card holder is considered the data owner for his or her assigned credit card number. Since a service provider needs to create an account for each data owner, the data owner is sometimes called the account owner.
“Hash”. Sometimes called a message digest. The encrypted output from one-way encryption. The hash, however, cannot be directly unencrypted to restore the original plaintext.
“One-Way Encryption”. Sometimes called cryptographic hash functions. A class of encryption algorithms which accept as input plaintext and in most cases also a salt value, and produce as output a generally unique hash value which cannot directly be decrypted back to input values. Examples of one-way encryption algorithms include MD5, SHA-512, and SHA-3.
“Plaintext”. Unencrypted data. As opposed to encrypted ciphertext.
“Salt”. A cryptographic salt, generally randomly generated. The salt is appended to plaintext data before one-way encryption as an added measure of security and uniqueness.
“Service Provider”. An organization providing services to many individual people or entities. For example, the organization running an online shopping web site would be considered a service provider.
“Symmetrical Encryption”. Sometimes also called private key encryption. It uses a single key for both encryption of plaintext to ciphertext, and decryption back from ciphertext to plaintext. Examples of symmetrical encryption algorithms include DES, AES, and Blowfish.

Account Creation Process:

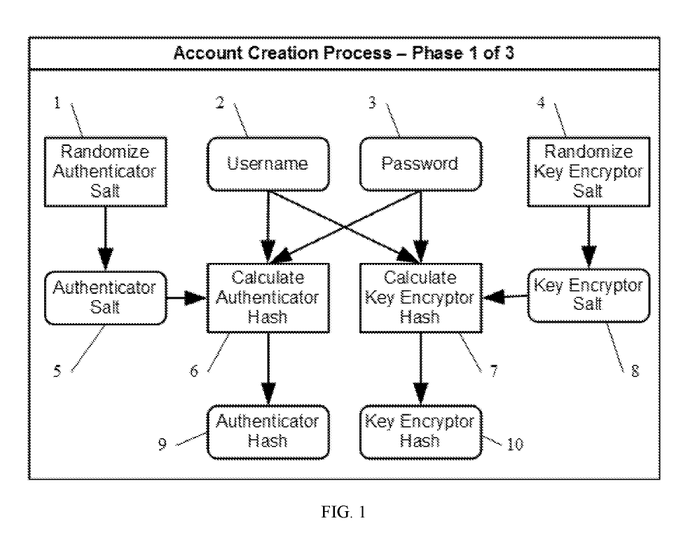

Before a data owner can share data with a service provider an account must be created for the data owner on a service provider host. FIG. 1 through FIG. 3 illustrate one example embodiment, but not the only possible embodiment, of this account creation process.

FIG. 1 illustrates the first phase of the account creation process. The Randomize Authenticator Salt step (1) generates a random Authenticator Salt (5) which is suitable for whatever one-way encryption algorithm is used later. Similarly, the Randomize Key Encryptor Salt step (4) generates a separate random Key Encryptor Salt (8). It is assumed that the data owner for whom this account applies has previously supplied a Username (2) and corresponding Password (3). The Username (2) can be any unique identifier and is used to uniquely identify an account. The Password (3) can be a typical user supplied password, passphrase, or some other secret key. The Calculate Authenticator Hash step (6) uses a one-way encryption algorithm which uses the Username (2), Password (3) and Authenticator Salt (5) as inputs and produces the Authenticator Hash (9) as output. Any secure one-way encryption algorithm, such as SHA-512, can be used. Similarly, the Calculate Key Encryptor Hash step (7) uses a one-way encryption algorithm which uses the Username (2), Password (3) and Key Encryptor Salt (8) as inputs and produces the Key Encryptor Hash (10) as output.

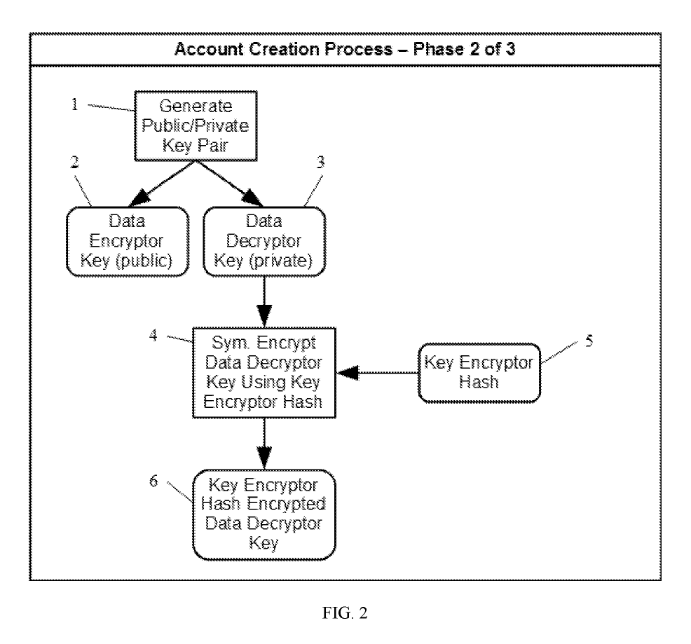

FIG. 2 illustrates the second phase of the account creation process. The Generate Public/Private Key Pair step (1) uses an asymmetric encryption algorithm to generate a public/private key pair consisting of the Data Encryptor Key (2) as the public key and the Data Decryptor Key (3) as the private key. Any secure asymmetrical encryption algorithm, such as RSA, can be used. The Sym. Encrypt Data Decryptor Key Using Key Encryptor Hash step (4) uses a symmetrical encryption algorithm to encrypt the Data Decryptor Key (3) into the Key Encryptor Hash Encrypted Data Decryptor Key (6) using the Key Encryptor Hash (5) generated in phase one as the encryption key. Any secure symmetrical encryption algorithm, such as AES, can be used.

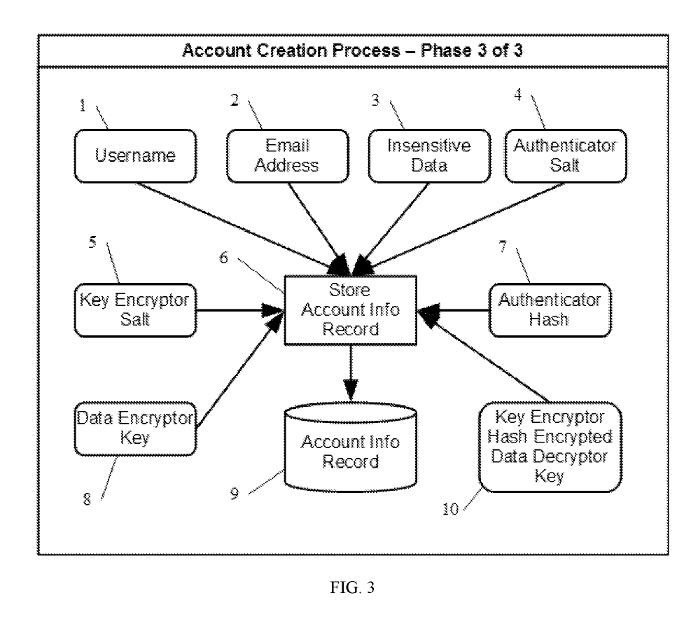

FIG. 3 illustrates the third phase of the account creation process. The Store Account Info Record step (6) stores the data owner provided Username (1), the data owner provided Email Address (2), the data owner provided Insensitive Data (3), the phase one generated Authenticator Salt (4), the phase one generated Key Encryptor Salt (5), the phase one generated Authenticator Hash (7), the phase two generated Data Encryptor Key (8), and the phase two generated Key Encryptor Hash Encrypted Data Decryptor Key (10) into a database as an Account Info Record (9). Note that the Email Address (2) is used in this example embodiment as sample alternate contact information, a cell phone number or similar contact method could be used in other embodiments. Also note that the Email Address (2) should be unique and used by this account only. Insensitive Data (3) represents data less sensitive that other sensitive data that we will encounter later. Sensitive data, described later, can only be accessed by the service provider during data owner authorized access sessions. Insensitive Data (3) can be accessed by the service provider anytime. An example of common insensitive data are account preferences, but many other types of data can fall into this category depending on the application. Also note that in this embodiment the Username should be a unique key for this record in the database table.

Account Logon Process:

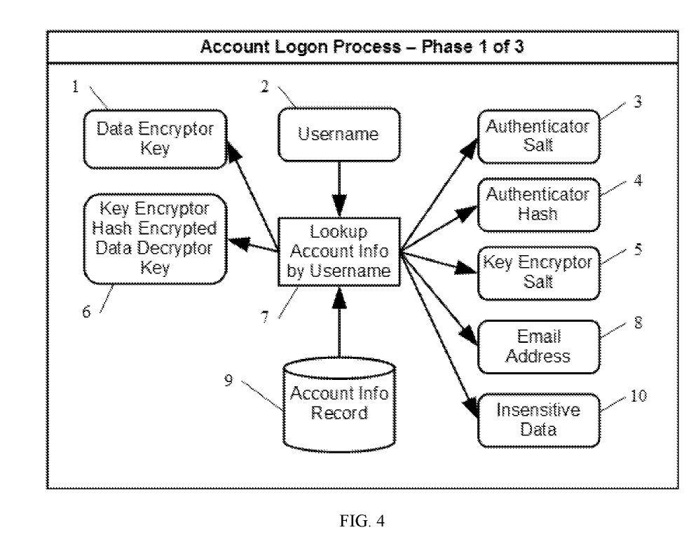

Once an account has been created the data owner must logon to the service provider computer system in order to use the system. FIG. 4 through FIG. 6 illustrate one example embodiment, but not the only possible embodiment, of this account logon process.

FIG. 4 illustrates the first phase of the account logon process. The Lookup Account Info by Username step (7) uses the data owner supplied Username (2) to lookup the corresponding Account Info Record (9) from the database in order to retrieve values for Data Encryptor Key (1), Key Encryptor Hash Encrypted Data Decryptor Key (6), Authenticator Salt (3), Authenticator Hash (4), Key Encryptor Salt (5), Email Address (8), and Insensitive Data (10).

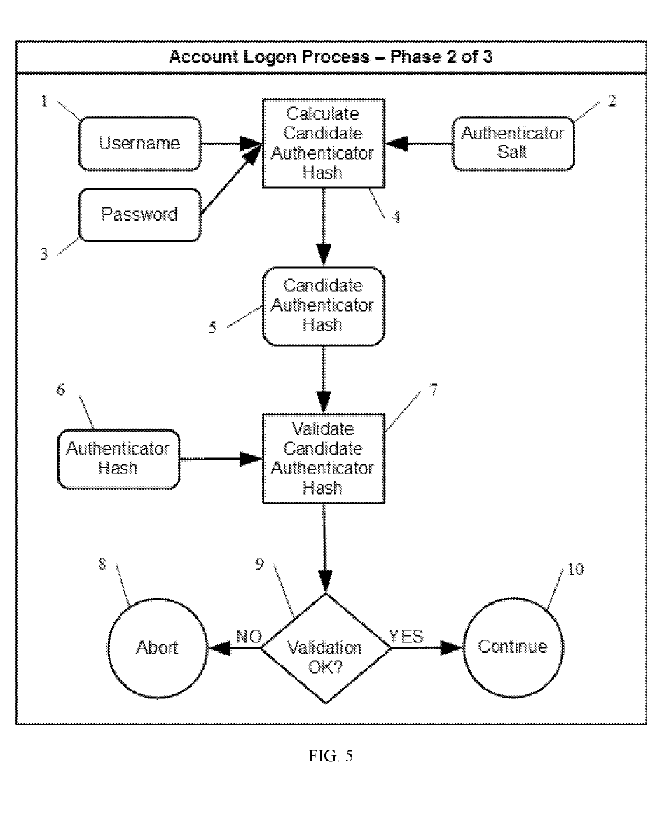

FIG. 5 illustrates the second phase of the account logon process. The Calculate Candidate Authenticator Hash step (4) inputs the data owner supplied Username (1), the data owner supplied Password (3), and the database retrieved Authenticator Salt (2) into the same one-way encryption function used during account creation. This produces the Candidate Authenticator Hash (5) as output. Next, the Validate Candidate Authenticator Hash step (7) compares the Candidate Authenticator Hash (5) to the database retrieved Authenticator Hash (6) in order to test decision Validation OK (9). If the two hashes are identical, then the validation is OK and the processes can Continue (10) to the next phase. If the two hashes are not identical, then the validation is not OK and the process will Abort (8) without continuing to the next phase.

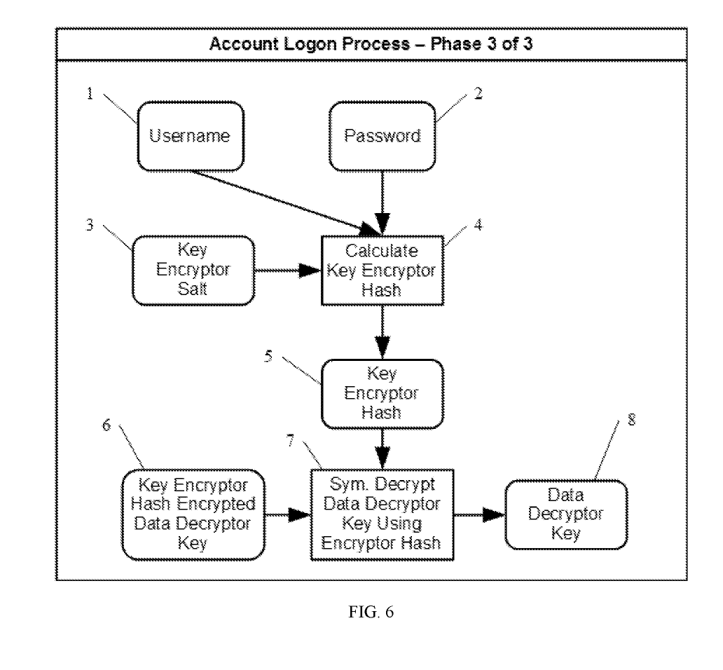

FIG. 6 illustrates the third phase of the account logon process. The Calculate Key Encryptor Hash step (4) inputs the data owner supplied Username (1), the data owner supplied Password (2), and the database retrieved Key Encryptor Salt (3) into the same one-way encryption function used during account creation. This produces the Key Encryptor Hash (5) as output. Next, the Sym. Decrypt Data Decryptor Key Using Encryptor Hash step (7) decrypts the Key Encryptor Hash Encrypted Data Decryptor Key (6) using the Key Encryptor Hash (5) as the decryption key and using the same symmetrical cryptographic algorithm used during account. This produces the Data Decryptor Key (8) as output.

Sensitive Data Storage Process:

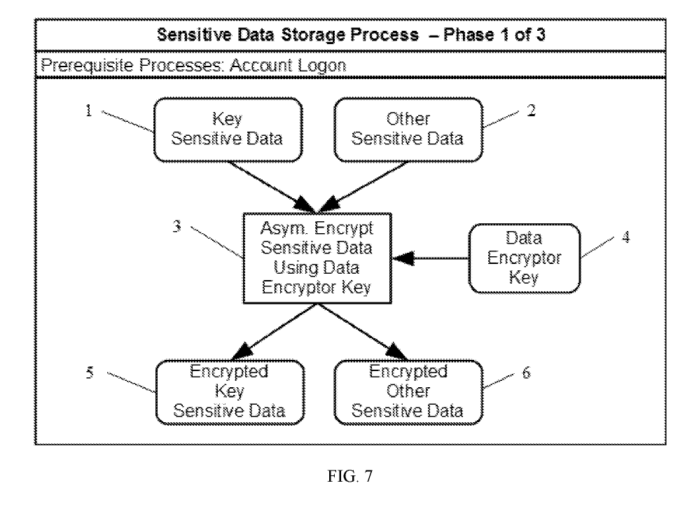

A data owner logged onto the service provider server has the option to store sensitive data. This is the data that is especially protected by this invention. Note that because the data owner must logon for this process, it is assumed that the data dynamically regenerated or retrieved from the database during the previous logon process are still available. FIG. 7 through FIG. 9 illustrate one example embodiment, but not the only possible embodiment, of the sensitive data storage process.

FIG. 7 illustrates the first phase of the sensitive data storage process. The Asym. Encrypt Sensitive Data Using Data Encryptor Key step (3) asymmetrically encrypts the data owner provided Key Sensitive Data (1) and data owner provided Other Sensitive Data (2) using the Data Encryptor Key (4) in order to produce the Encrypted Key Sensitive Data (5) and Encrypted Other Sensitive Data (6). Recall that the Data Encryptor Key (4) is retrieved from the database during user logon. Key Sensitive Data (1) and Other Sensitive Data (2) contain the sensitive data to receive special protection by this invention. Key Sensitive Data (1) is that portion of sensitive data that is used as part of a special password reset authentication process described later.

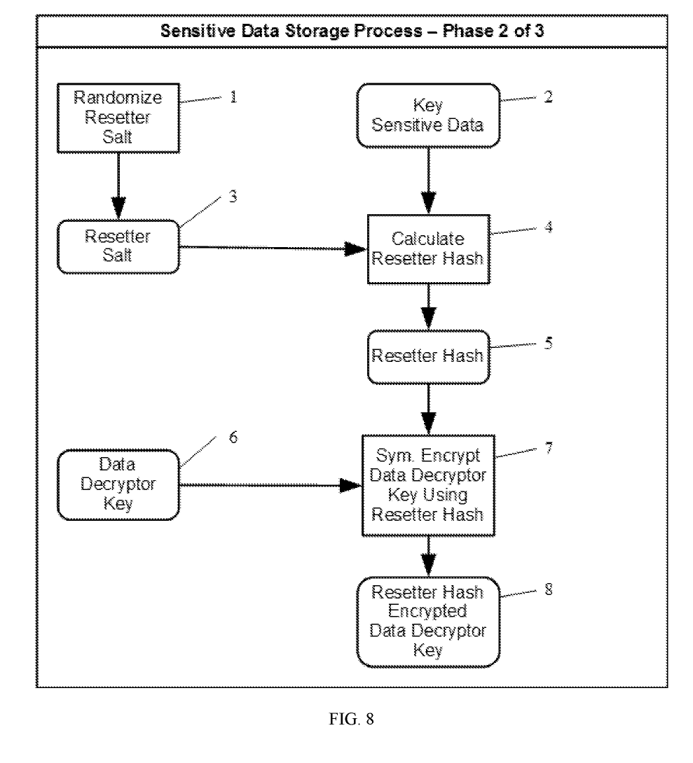

FIG. 8 illustrates the second phase of the sensitive data storage process. The Randomize Resetter Salt step (1) generates the Resetter Salt (3), which is a cryptographic salt suitable for use with a one-way encryption function. The Calculate Resetter Hash step (4) applies a one-way encryption function to the Key Sensitive Data (2) and Resetter Salt (3) thus producing the Resetter Hash (5). Any secure one-way algorithm can be used, but it is recommended to use the same one-way encryption algorithm used during account creation. The Sym. Encrypt Data Decryptor Key Using Resetter Hash step (7) symmetrically encrypts the Data Decryptor Key (6) using the Resetter Hash (5) as the encryption key thus producing the Resetter Hash Encrypted Data Decryptor Key (8). Any secure symmetrical encryption algorithm can be used but it is recommended to use the same symmetrical encryption algorithm used during account creation. Recall that the Data Decryptor Key (6) is restored during the account logon process.

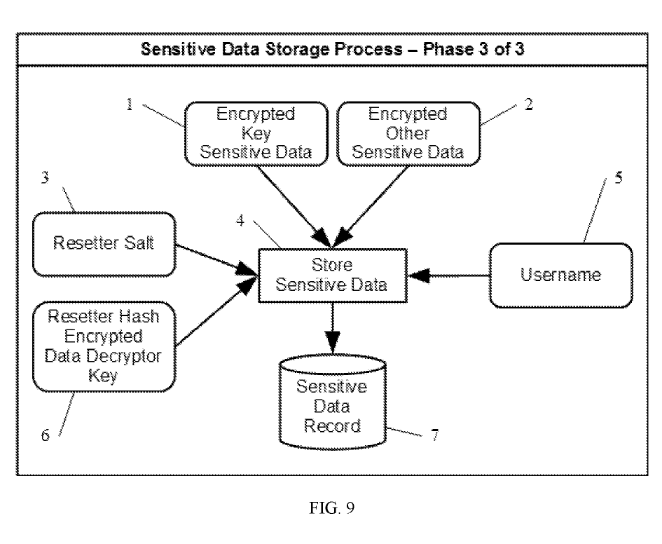

FIG. 9 illustrates the third phase of the sensitive data storage process. The Store Sensitive Data step (4) stores the Encrypted Key Sensitive Data (1), the Encrypted Other Sensitive Data (2), the Resetter Salt (3), the Username (5), and the Resetter Hash Encrypted Data Decryptor Key (6) into a database as a Sensitive Data Record (7).

Sensitive Data Retrieval Process:

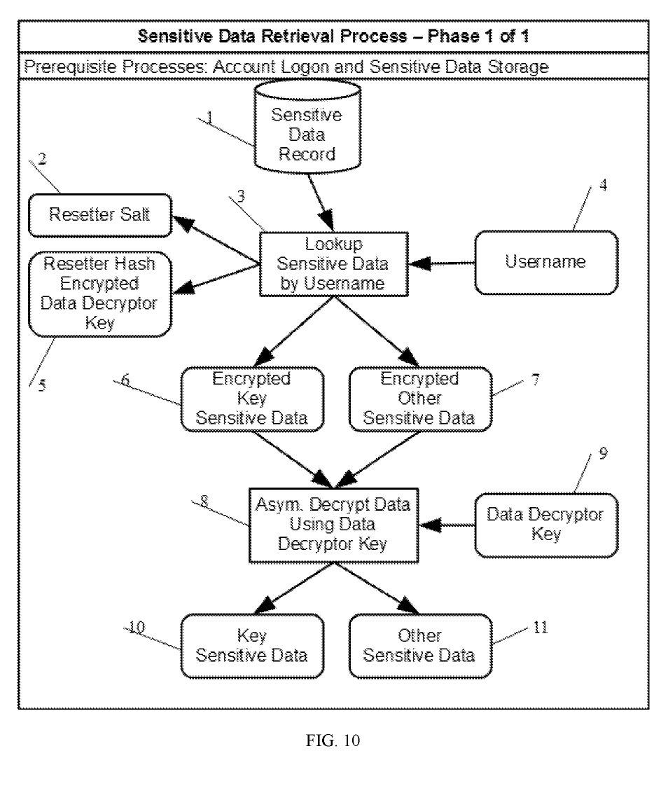

A data owner logged onto the service provider server who has previously stored sensitive data on the server, even if stored during a different session, has the option to retrieve this sensitive data. Note that because the data owner must logon for this process that it is assumed that the data dynamically regenerated or retrieved from the database during the previous logon process are still available. FIG. 10 illustrates one example embodiment, but not the only possible embodiment, of the sensitive data retrieval process.

FIG. 10 illustrates the sensitive data retrieval process. The Lookup Sensitive Data by Username step (3) uses Username (4) to retrieve the appropriate Sensitive Data Record (1) from the database. Note that Username (4) is set during the prerequisite account logon process. By reading fields from the Sensitive Data Record (1) values are set for Resetter Salt (2), Resetter Hash Encrypted Data Decryptor Key (5), Encrypted Key Sensitive Data (6), and Encrypted Other Sensitive Data (7). Next, the Asym. Decrypt Data Using Data Decryptor Key step (8) asymmetrically uses the Data Decryptor Key (9) to decrypt Encrypted Key Sensitive Data (6) and Encrypted Other Sensitive Data (7) to produce the corresponding unencrypted Key Sensitive Data (10) and Other Sensitive Data (11). Note that the Data Decryptor Key (9) was restored during the prerequisite account logon process.

Change Password Process:

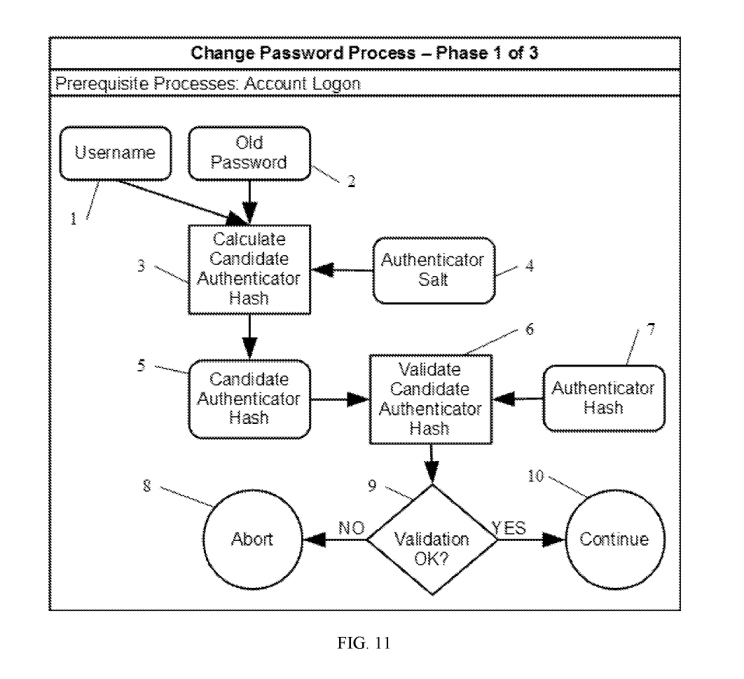

A data owner logged onto the service provider server has the option to change their password. This is the normal process to change a password, when the data owner still remembers the old password, as opposed to a password reset (described later) performed when a data owner forgets their password. Note that because the data owner must logon for this process that it is assumed that the data dynamically regenerated or retrieved from the database during the previous logon process are still available. FIG. 11 through FIG. 13 illustrate one example embodiment, but not the only possible embodiment, of the change password process.

FIG. 11 illustrates the first phase of the change password process. The Username (1) is already set from the account logon process. For additional security the data owner is asked to resupply the Old Password (2). The old Authenticator Salt (4) was also restored during the Account logon process. The Calculate Candidate Authenticator Hash step (3) then uses the Username (1), Old Password (2), and Authenticator Salt (4) to generate the Candidate Authenticator Hash (5) using the same one-way encryption algorithm used during the account creation process. The Validate Candidate Authenticator Hash step (6) then compares the Candidate Authenticator Hash (5) to the Authenticator Hash (7). Recall that the Authenticator Hash (7) is also restore during the account logon process. These two hashes are compared by the Validation OK test (9). If the hashes are identical then the process will Continue (10) to the next phase, otherwise the entire process will Abort (8).

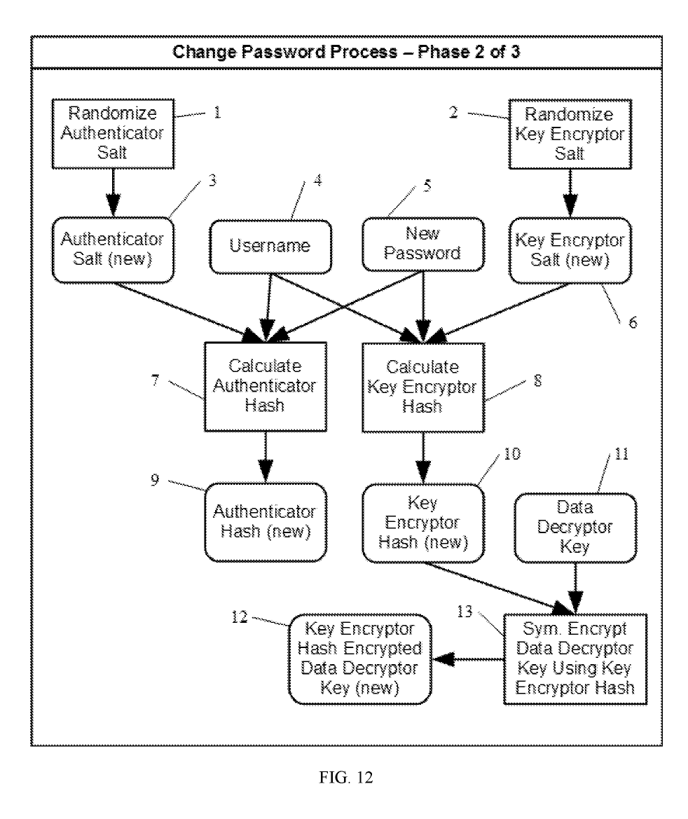

FIG. 12 illustrates the second phase of the change password process. The Username (4) and Data Decryptor Key (11) are set during the prerequisite account logon process. The data owner is asked to provide a New Password (5). The Randomize Authenticator Salt step (1) generates a new cryptographic Authenticator Salt (3). Similarly, the Randomize Key Encryptor Salt step (2) generates another new cryptographic Key Encryptor Salt (6). The Calculate Authenticator Hash step (7) invokes the appropriate one-way encryption algorithm which uses the new Authenticator Salt (3), the Username (4), and the New Password (5) as inputs and produces the new Authenticator Hash (9) as output. Similarly, the Calculate Key Encryptor Hash step (8) invokes the appropriate one-way encryption algorithm which uses the new Key Encryptor Salt (6), the Username (4), and the New Password (5) as inputs and produces the new Key Encryptor Hash (10) as output. Then the Sym. Encrypt Data Decryptor Key Using Key Encryptor Hash step (13) symmetrically encrypts the Data Decryptor Key (11) using the Key Encryptor Hash (10) as the encryption key, thus producing a new Key Encryptor Hash Encrypted Data Decryptor Key (12). Note that the underlying sensitive data (if any) does not have to be re-encrypted, only the decryption key to the sensitive data, the Data Decryptor Key (11), is re-encrypted.

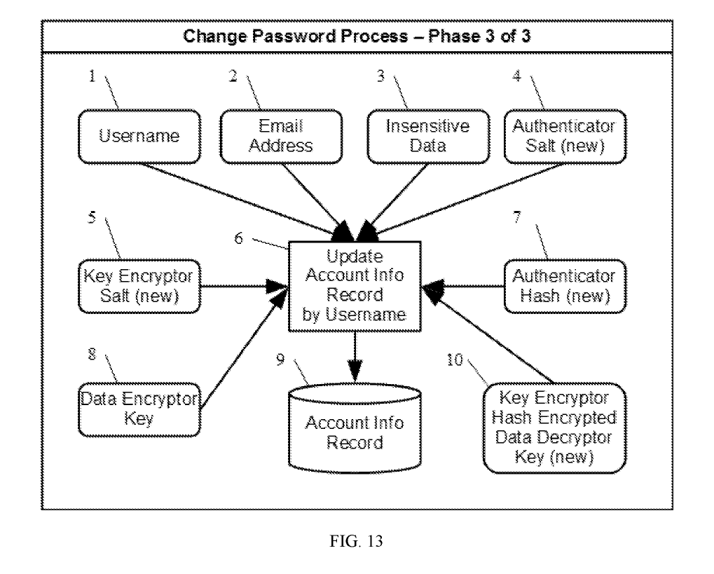

FIG. 13 illustrates the third phase of the change password process. The Update Account Info Record by Username step (6) updates the existing Account Info Record (9) in the database. The Username (1) is used to identify the old record. The values for Username (1), Email Address (2), Insensitive Data (3), and Data Encryptor Key (8) should be the same, but new values from Authenticator Salt (4), Key Encryptor Salt (5), Authenticator Hash (7), and Key Encryptor Hash Encrypted Data Decryptor Key (10) are saved as new values in the updated Account Info Record (9). This complete the change password process.

Reset Password Process:

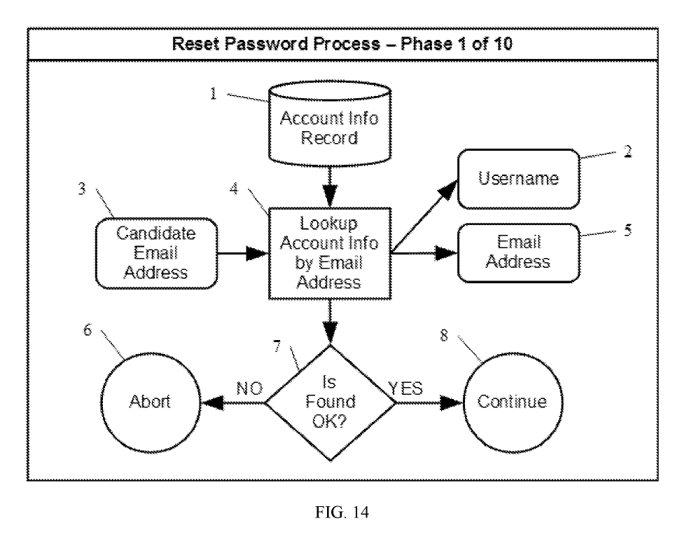

A data owner who forgets the account password must request a special password reset in order to regain access to the service provider server. FIG. 14 through FIG. 23 illustrate one example embodiment, but not the only possible embodiment, of the reset password process.

FIG. 14 illustrates the first phase of the reset password process. The data owner does not need to logon, after all they apparently do not remember their password. But they can request a password reset which in this embodiment will ask them for a Candidate Email Address (3). Note that in other embodiments other communication channels such as cell phone text messages are possible. The Lookup Account Info by Email Address step (4) uses the Candidate Email Address (3) to find the unique Account Info Record (1) in the database and to set Username (2) and Email Address (5) from values in that record. The Is Found OK test (7) checks to verify that one and only one Account Info Record (1) was retrieved. If one record is not found the process will Abort (6) and no more phases will execute. Otherwise the process will Continue (8) to the next phase.

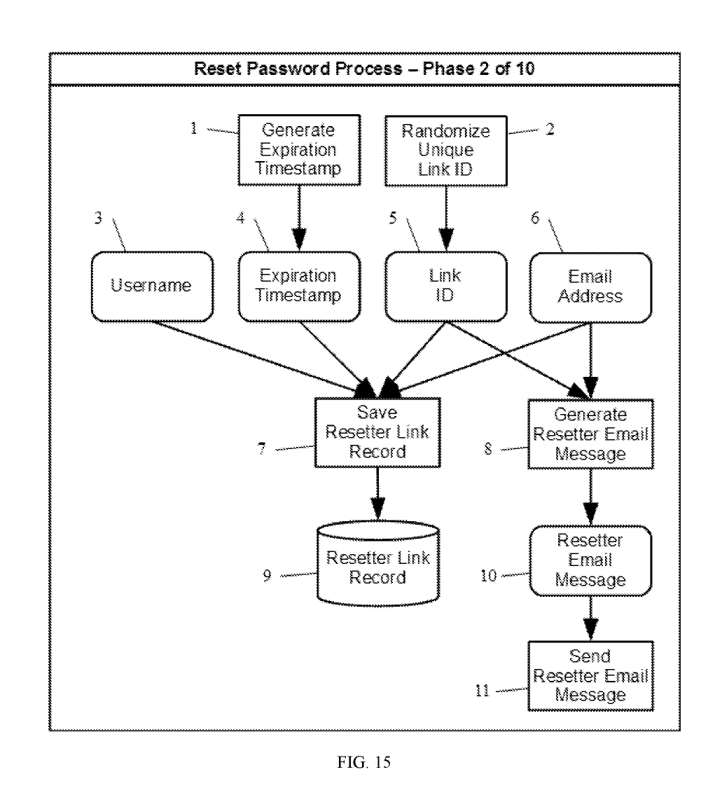

FIG. 15 illustrates the second phase of the reset password process. The Generate Expiration Timestamp step (1) will create an Expiration Timestamp (4), which is far enough in the future to reasonably allow for the reset password process to complete; an hour should generally be sufficient. The Randomize Unique Link ID step (2) generates a random Link ID (5) which uniquely identifies this reset password request. The Save Resetter Link Record step (7) then writes a Resetter Link Record (9) to the database using the Username (3), the Expiration Timestamp (4), the Link ID (5), and the Email Address (6). Recall that Username (3) and Email Address (6) were set in the previous phase. The Generate Resetter Email Message step (8) then creates a formatted Resetter Email Message (10) which includes a clickable web link with the Link ID (5) embedded into the URL and which also specifies the data owner Email Address (6) as the recipient of the message. Next, the Send Resetter Email Message step (11) actually sends the Resetter Email Message (10) to the data owner.

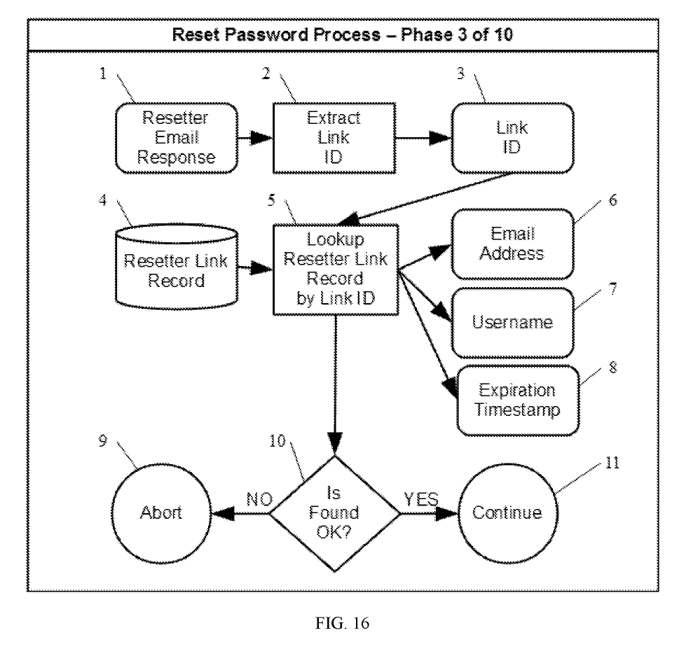

FIG. 16 illustrates the third phase of the reset password process. When the data owner receives the reset email message they then click on the embedded web link, which invokes on the service provider server the Extract Link ID step (2), which extracts the Link ID (3) from the Resetter Email Response (1). The Lookup Resetter Link Record by Link ID step (5) uses the Link ID (3) to find the corresponding Resetter Link Record (4) in the database and uses that record to set Email Address (6), Username (7), and Expiration Timestamp (8). The Is Found OK test (10) validates that an appropriate Resetter Link Record (4) was found. If not found the reset password process will Abort (9). Otherwise the process will Continue (11) to the next phase.

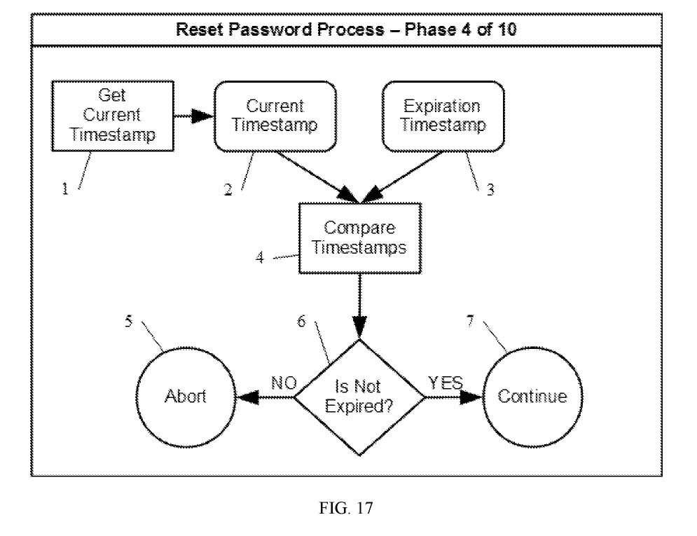

FIG. 17 illustrates the forth phase of the reset password process. The Get Current Timestamp step (1) simply reads the server clock and sets Current Timestamp (2). The Compare Timestamps step (4) compares the Current Timestamp (2) to the Expiration Timestamp (3). Recall that Expiration Timestamp (3) was restored from the database in the previous phase. The Is Not Expired test (6) will Abort (5) if the reset window has expired. Otherwise, the reset password process will Continue (7) to the next phase.

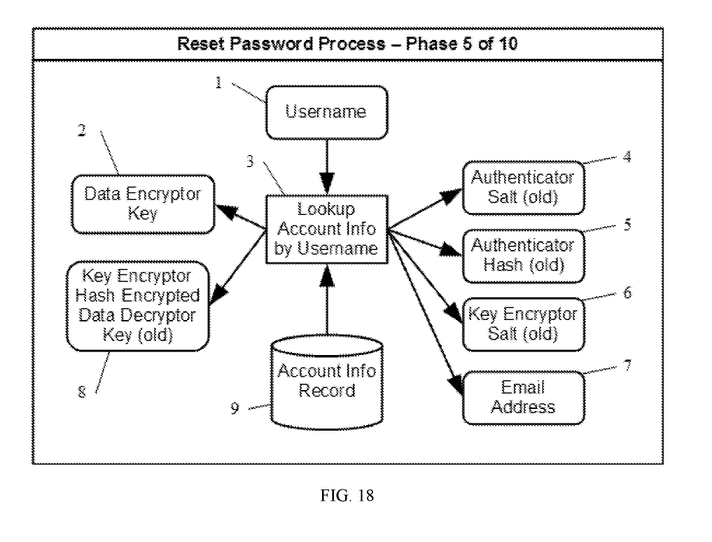

FIG. 18 illustrates the fifth phase of the reset password process. The Lookup Account Info by Username step (3) uses the Username (1) to find the appropriate Account Info Record (9) in order to set values for Data Encryptor Key (2), Key Encryptor Hash Encrypted Data Decryptor Key (8), Authenticator Salt (4), Authenticator Hash (5), Key Encryptor Salt (6), and Email Address (7). Recall that Username (1) was previously restored from the database in a previous phase.

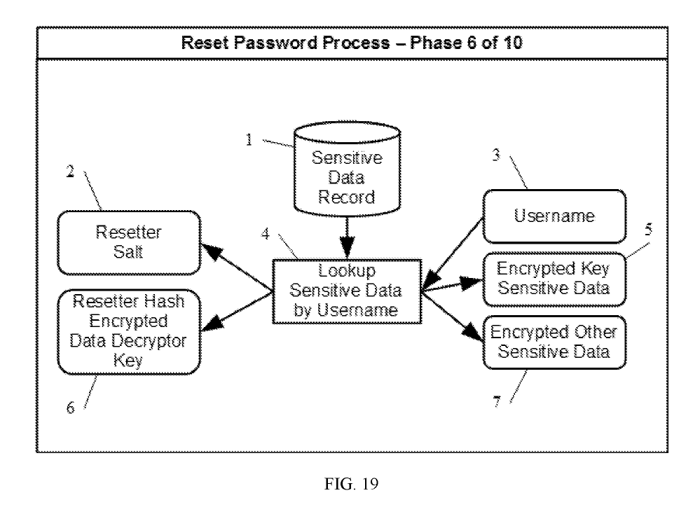

FIG. 19 illustrates the sixth phase of the reset password process. The Lookup Sensitive Data by Username step (4) uses the Username (3) to find the corresponding Sensitive Data Record (1) in order to set values for Resetter Salt (2), Resetter Hash Encrypted Data Decryptor Key (6), Encrypted Key Sensitive Data (5), and Encrypted Other Sensitive Data (7). Recall that Username (1) was previously restored from the database in a previous phase.

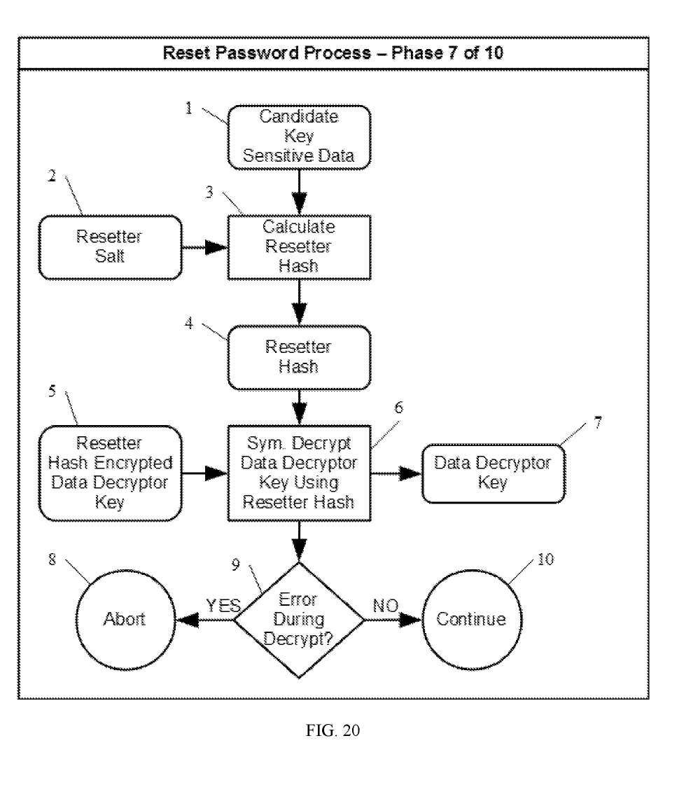

FIG. 20 illustrates the seventh phase of the reset password process. The Calculate Resetter Hash step (3) uses a one-way encryption algorithm to generate the Resetter Hash (4) using Candidate Key Sensitive Data (1) and Resetter Salt (2) as inputs. In this embodiment, the preceding email interactions verify that the user has access to the appropriate email account. By specifying Candidate Key Sensitive Data here the invention begins to verify something the user knows, such as a credit card number, their mother's maiden name, of some other appropriate item of sensitive data. The Sym. Decrypt Data Decryptor Key Using Resetter Hash step (6) uses the just generated Resetter Hash (4) as the decryption key in an attempt to decrypt the Resetter Hash Encrypted Data Decryptor Key (5) with the appropriate symmetrical cryptographic algorithm and produce the Data Decryptor Key (7). The Error During Decrypt test (9) checks this decryption process. If a decryption error is detected the reset password process will Abort (8). Otherwise the reset password process will Continue (10) to the next phase.

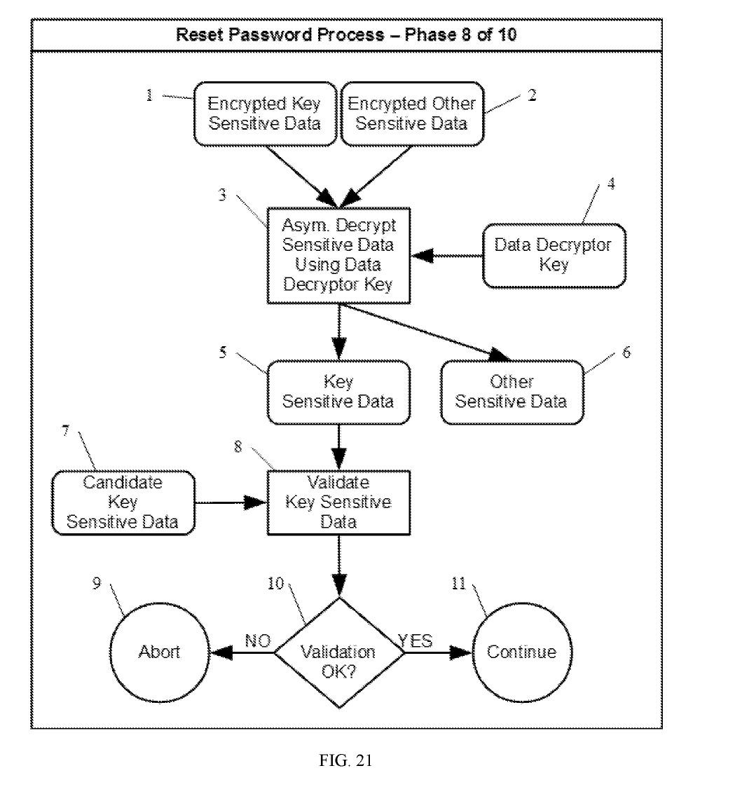

FIG. 21 illustrates the eighth phase of the reset password process. The Asym. Decrypt Sensitive Data using Data Decryptor Key step (3) decrypts Encrypted Key Sensitive Data (1) and Encrypted Other Sensitive Data (2) using the appropriate asymmetrical cryptographic algorithm using the Data Decryptor Key (4) as the key, thus producing Key Sensitive Data (5) and Other Sensitive Data (6). Recall that Encrypted Key Sensitive Data (1), Encrypted Other Sensitive Data (2), and Data Decryptor Key (4) were set by previous phases. The Validate Key Sensitive Data step (8) compares the just decrypted Key Sensitive Data (5) to the Candidate Key Sensitive Data (7) the user previously provided. If the data are not identical, the Validation OK test (10) will Abort (9) the reset password process. Otherwise the reset password process will Continue (11) to the next phase.

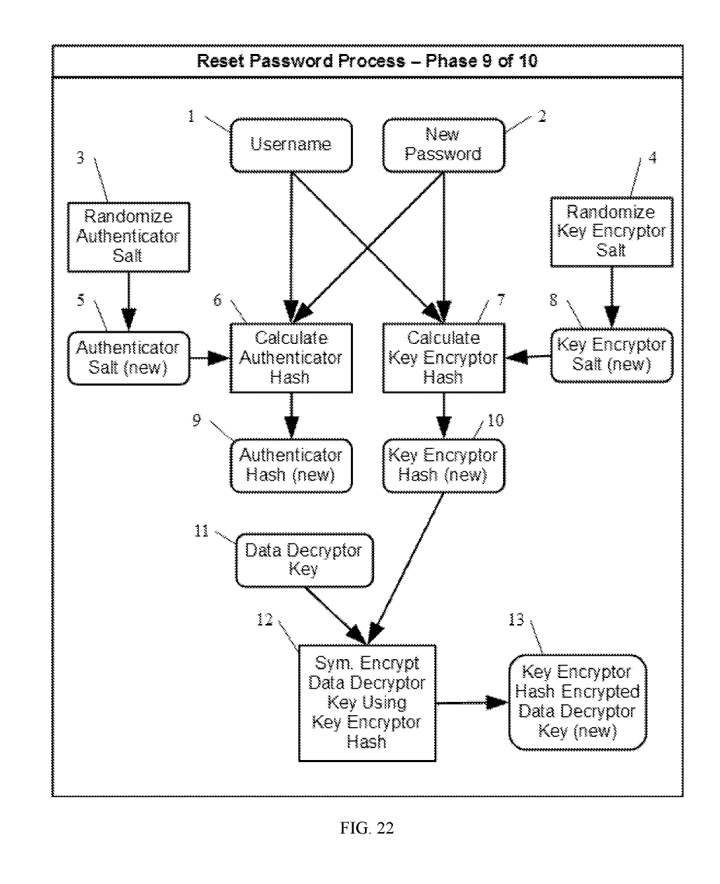

FIG. 22 illustrates the ninth phase of the reset password process. The Randomize Authenticator Salt step (3) generates a new random cryptographically appropriate Authenticator Salt (5). The Randomize Key Encryptor Salt step (4) generates a new random cryptographically appropriate Key Authenticator Salt (8). The Calculate Authenticator Hash step (6) uses a one-way encryption algorithm which generates a new Authenticator Hash (9) from Username (1), a newly selected New Password (2), and the new Authenticator Salt (5). The Calculate Key Encryptor Hash step (7) uses a one-way encryption algorithm which generates a new Key Encryptor Hash (10) from Username (1), the New Password (2), and the new Key Encryptor Salt (8). The Sym. Encrypt Data Decryptor Key Using Key Encryptor Hash step (12) uses a symmetrical encryption algorithm to encrypt the Data Decryptor Key (11) using the Key Encryptor Hash (10) as the encryption key thus producing the Key Encryptor Hash Encrypted Data Decryptor Key (13). Recall that Username (1) and Data Decryptor Key (11) were set in previous phases.

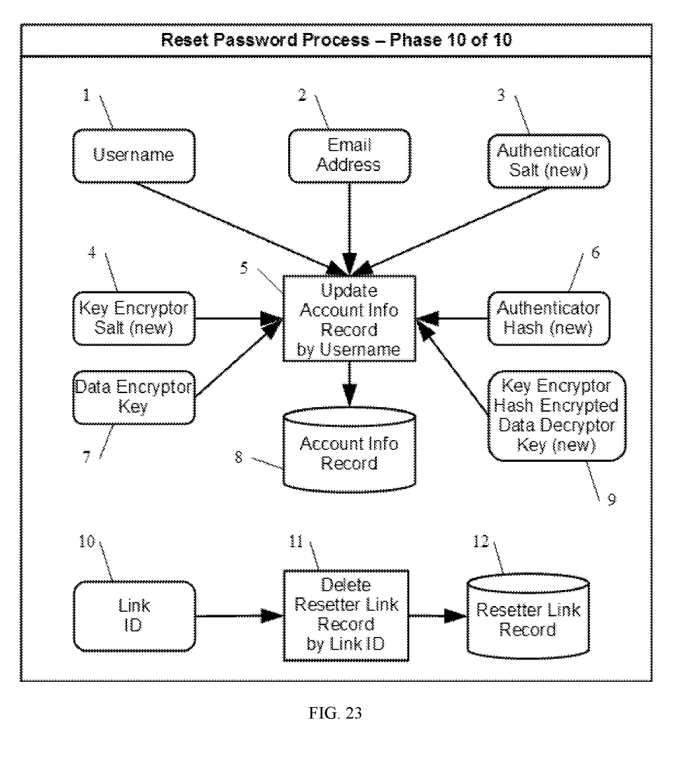

FIG. 23 illustrates the tenth phase of the reset password process. The Update Account Info Record by Username step (5) uses the Username (1) to find the corresponding Account Info Record (8) in the database and updates it using the new values for Authenticator Salt (3), Key Encryptor Salt (4), Authenticator Hash (6), and Key Encryptor Hash Encrypted Data Decryptor Key (9). Values for Email Address (2) and Data Encryptor Key (7) should not have changed. Next, the Delete Resetter Link Record by Link ID step (11) deletes the Corresponding Resetter Link Record (12) from the database using the Link ID (10) value to uniquely identify the record.

I claim:

1. Methods to setup cryptographic keys and hashes during user account setup in a manner which allows data owners to retain more access control over their sensitive data stored encrypted in service provider databases.

2. Methods to restore cryptographic keys and hashes previously setup during user logon in a manner which supports subsequent temporary access to sensitive data stored encrypted in service provider databases.

3. Methods to store sensitive information in an encrypted form on service provider databases such that the original data owner still controls when this information is or is not available to the service provider.

4. Methods to read and decrypt previously encrypted sensitive information stored on service provider databases in a manner which only a logged on data owner or their proxy can perform.

5. Methods to change an account password when the old password is available which preserve data owner access to encrypted sensitive data previously stored without requiring re-encryption of data owner sensitive data.

6. Methods to reset an account password when the old password is lost or forgotten which preserve data owner access to encrypted sensitive data previously stored without requiring re-encryption of data owner sensitive data.
